(19) United States
(12) Patent Application Publication
(10) Pub. No.: US 2016/0246705 A1
(43) Pub. Date: Aug. 25, 2016

(54) DATA FABRICATION BASED ON TEST REQUIREMENTS

(71) Applicant: International Business Machines Corporation, Armonk, NY (US)

(72) Inventors: Akram Bitar, Kfar Peqiin (IL); OLEG BLINDER, Haifa (IL); Ronen Levy, Haifa (IL); Tamer Salman, Haifa (IL)

(21) Appl. No.: 14/628,317

(22) Filed: Feb. 23, 2015

(51) Int. Cl. G06F 11/36

(52) U.S. Cl. CPC G06F 11/3672; G06F 11/3664

(57) ABSTRACT

A method for fabricating test data, comprising using a hardware processor for: receiving a plurality of data sources; receiving a plurality of targets to be populated with the test data; obtaining a plurality of data fabrication rules; receiving a fabrication use-case having a hierarchic structure and comprising one or more tasks each associated with one or more data fabrication rules and with a set of targets; formulating at least some of the data fabrication rules as corresponding constraints; and performing the following steps for each task according to the hierarchic structure of the fabrication use-case: applying, to data sources the constraints corresponding to at least some data fabrication rules associated with said each task to receive a solution, and (b) populating the associated set of targets with the solution, to receive fabricated test data.

### BACKGROUND

The present invention relates to the field of data fabrication in general and to generating data for testing applications in particular.

Obtaining high-quality test data fabrication based on test requirements is quite a challenge. This may be critical for large scale enterprise data-intensive or data-driven applications that may not be tested for one or more of the following reasons: Existing data from customers may not be used due to privacy issues; partial data exists, though it needs to be further enhanced with additional data; no data exists for testing, and it is not trivial to create data which meets structural and other requirements (e.g., referential integrity in relational databases, business-logic requirement, and test requirements); and changes have occurred either in the resources metadata or data or in the business logic of the application, and these changes require transformation of existing data.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in accordance with an embodiment, a method for fabricating test data, comprising using at least one hardware processor for: receiving a plurality of data sources; receiving a plurality of targets to be populated with the test data; obtaining a plurality of data fabrication rules; receiving a fabrication use-case having a hierarchic structure and comprising one or more tasks each associated with one or more data fabrication rules of the plurality of data fabrication rules and with a set of targets of the plurality of targets; formulating at least some of the one or more data fabrication rules as corresponding one or more constraints; and performing the following steps for each task of the one or more tasks of the fabrication use-case, according to the hierarchic structure of the fabrication use-case: applying, to data sources of the plurality of data sources, the one or more constraints corresponding to at least some data fabrication rules of the one or more data fabrication rules associated with said each task, according to the hierarchic structure of the fabrication use-case, to receive a solution, and populating the associated set of targets with the solution, to receive fabricated test data for the associated set of targets.

There is provided, in accordance with another embodiment, a computer program product comprising a non-transitory computer-readable storage medium having program code embodied therewith, the program code executable by at least one hardware processor to: receive a plurality of data sources; receive a plurality of targets to be populated with the test data; obtain a plurality of data fabrication rules; receive a fabrication use-case having a hierarchic structure and comprising one or more tasks each associated with one or more data fabrication rules of the plurality of data fabrication rules and with a set of targets of the plurality of targets; formulate at least some of the one or more data fabrication rules as corresponding one or more constraints; and perform the following steps for each task of the one or more tasks of the fabrication use-case, according to the hierarchic structure of the fabrication use-case: apply, to data sources of the plurality of data sources, the one or more constraints corresponding to at least some data fabrication rules of the one or more data fabrication rules associated with said each task and with each parent task of said each task, according to the hierarchic structure of the fabrication use-case, to receive a solution, and populate the associated set of targets with the solution, to receive fabricated test data for the associated set of targets.

There is provided, in accordance with a further embodiment, a system comprising: a storage device having stored thereon instructions for: receiving a plurality of data sources, receiving a plurality of targets to be populated with the test data, obtaining a plurality of data fabrication rules, receiving a fabrication use-case having a hierarchic structure and comprising one or more tasks each associated with a set of targets of the plurality of targets and with one or more data fabrication rules of the plurality of data fabrication rules, formulating at least some of the one or more data fabrication rules as corresponding one or more constraints, and performing the following steps for each task of the one or more tasks of the fabrication use-case, according to the hierarchic structure of the fabrication use-case: applying, to data sources of the plurality of data sources, the one or more constraints corresponding to at least some data fabrication rules of the one or more data fabrication rules associated with said each task and with each parent task of said each task, according to the hierarchic structure of the fabrication use-case, to receive a solution, and populating the associated set of targets with the solution, to receive fabricated test data for the associated set of targets; and at least one hardware processor configured to execute said instructions.

In some embodiments, the fabrication use-case comprises a set of use-cases hierarchically structured, and wherein each use-case of said set of use-cases which is in the bottom level of the hierarchic structure of the set of use-cases comprises at least one task of said one or more tasks.

In some embodiments, each task of said one or more tasks is associated with at least one number of records of test data to be fabricated for each target of the set of targets associated with said each task, each such at least one number of records is associated in a hierarchic level of the fabrication use-case selected from the group consisting of: a fabrication use-case level, use-cases level and tasks level, and the applying of the one or more constraints on data sources to receive the solution and the populating of the associated set of targets with the solution are repeated for said each task until the total number of records associated with said each task is satisfied.

In some embodiments, the type of at least some of said plurality of data fabrication rules is selected from the group consisting of: constraint rules, transformation rules, knowledge-base rules, programmatic rules, analytics rules and generic rules.

In some embodiments, the method further comprises using said at least one hardware processor for: parsing and dividing generic rules of the plurality of data fabrication rules into rule components according to the types of the rule components; for each analytics rule of the plurality of data fabrication rules: performing the analytics defined in said each analytics rule on at least one data source of the plurality of data sources to receive one or more distributions, and formulating the received one or more distributions as one or more constraints; for each knowledge-base rule of the plurality of data fabrication rules, reading a knowledge-base associated with said each knowledge-base rule and formulating a constraint accordingly, wherein said plurality of data sources comprises said knowledge-base; for each programmatic rule of the plurality of data fabrication rules, executing said each programmatic rule at least once for each associated target to receive at least one value for said each associated target; and formulating constraint rules of the plurality of data fabrication rules as constraints.

In some embodiments, the performing of the steps for each task of the one or more tasks further comprises performing the following steps: for each transformation rule of the plurality of data fabrication rules which is defined with respect to a data source of the plurality of data sources, applying the transformation defined by said each transformation rule on the data source, and for each transformation rule of the plurality of data fabrication rules which is defined with respect to a target of the plurality of targets, applying the transformation defined by said each transformation rule on the target.

In some embodiments, the applying of the one or more constraints on the data sources comprises formulating and solving a Constraint Satisfaction Problem (CSP) according to the one or more constraints to receive the solution.

In some embodiments, the method further comprises: dividing the one or more constraints to unrelated constraints and performing the steps for each task in a separate manner for each one of the unrelated constraints.

In some embodiments, the data fabrication rules are hierarchically structured.

In some embodiments, the data fabrication rules are derived from sources selected from the group consisting of: data logic, application logic and test logic.

In some embodiments, entities of targets of the plurality of targets and of sources of the plurality of sources are tagged with stereotypes, and wherein the method further comprises using said at least one hardware processor for: receiving one or more meta-rules defined to be enforced with respect to the entities tagged with the stereotypes; and instantiating said one or more meta-rules to produce one or more data fabrication rules referring to the entities tagged with the stereotypes correspondingly.

In some embodiments, entities selected from the group consisting of: tables and attributes of tables are defined as one or more groups and wherein data fabrication rules of the plurality of data fabrication rules and the stereotypes may be defined with respect to the one or more groups.

In some embodiments, the one or more data fabrication rules are associated with said each task in a hierarchic level of the fabrication use-case selected from the group consisting of: a fabrication use-case level, use-cases level and tasks level.

In some embodiments, the program code is further executable by said at least one hardware processor to: parse and divide generic rules of the plurality of data fabrication rules into rule components according to the types of the rule components; for each analytics rule of the plurality of data fabrication rules: perform the analytics defined in said each analytics rule on at least one data source of the plurality of data sources to receive one or more distributions, and formulate the received one or more distributions as one or more constraints; for each knowledge-base rule of the plurality of data fabrication rules, read a knowledge-base associated with said each knowledge-base rule and formulate a constraint accordingly, wherein said plurality of data sources comprises said knowledge-base; for each programmatic rule of the plurality of data fabrication rules, execute said each programmatic rule at least once for each associated target to receive at least one value for said each associated target; and formulate constraint rules of the plurality of data fabrication rules as constraints.

In some embodiments, said storage device is further having stored thereon instructions for: parsing and dividing generic rules of the plurality of data fabrication rules into rule components according to the types of the rule components; for each analytics rule of the plurality of data fabrication rules: performing the analytics defined in said each analytics rule on at least one data source of the plurality of data sources to receive one or more distributions, and formulating the received one or more distributions as one or more constraints; for each knowledge-base rule of the plurality of data fabrication rules, reading a knowledge-base associated with said each knowledge-base rule and formulating a constraint accordingly, wherein said plurality of data sources comprises said knowledge-base; for each programmatic rule of the plurality of data fabrication rules, executing said each programmatic rule at least once for each associated target to receive at least one value for said each associated target; and formulating constraint rules of the plurality of data fabrication rules as constraints.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 shows a flowchart of a method, in accordance with an embodiment;

FIG. 2 shows an exemplary structure of a task, according to an embodiment;

FIG. 3 shows an exemplary structure of a fabrication use-case, according to an embodiment;

FIG. 4 shows an exemplary structure of a use-case hierarchy, according to an embodiment;

FIG. 5 shows an exemplary use-case, according to an embodiment; and

FIG. 6 shows an exemplary system, according to an embodiment.

### DETAILED DESCRIPTION

The disclosed data fabrication allows fabricating test data according to rules. The rules describe requirements which the fabricated data is required to satisfy, mainly in order to simulate real data. These rules may be defined by a testing engineer (i.e., a user) and/or may be automatically obtained from the involved environments. The disclosed data fabrication further allows fabrication of test data based on a combination of various rule types (such as analytics, constraints, transformation etc.), which are based on business logic and testing logic on top of data logic. The disclosed data fabrication may be a Constraint Satisfaction Problem (CSP) based data fabrication solution.

Such rules may allow fabrication of test data which represent real world data, i.e., by having similar characteristics, and thus fabrication of reliable data. For example, certain attributes of the generated data may have the same distribution as the real world data. As another example, the values of certain attributes of the generated data may comply with some constraints. Furthermore, such rules may allow corner case testing.

The data fabrication process according to the disclosed data fabrication may be hierarchical, to allow an ordered, efficient and easy-to-define fabrication process. Accordingly, hierarchical requirements and thus hierarchical rules may be utilized.

The disclosed data fabrication may support generation of new data, transformation of existing data or a combination thereof. For example, when testing a shop application, data relating to existing purchases and orders for some products may be used. However, private data relating to the clients who made these orders, such as names, addresses, and credit card information may not be used. Thus, according to the disclosed data fabrication, one may fabricate clients and their information, but may still use the details of the orders and purchases.

The disclosed data fabrication may be used for generating data which may be utilized for developing and testing applications (e.g., large scale enterprise data-intensive or data-driven applications) for which not enough data is available or accessible. Since no real data may be used in the generation of the test data, no privacy or other regulations related to the real data may be infringed.

Hence, the disclosed data fabrication may allow intensive generation of high-quality and diverse test data (i.e., according to various requirements) or the transformation of existing data without violating privacy policies and in an automatic and relatively simple manner.

The term “rules” as referred to herein, may relate to data fabrication rules and/or meta-rules.

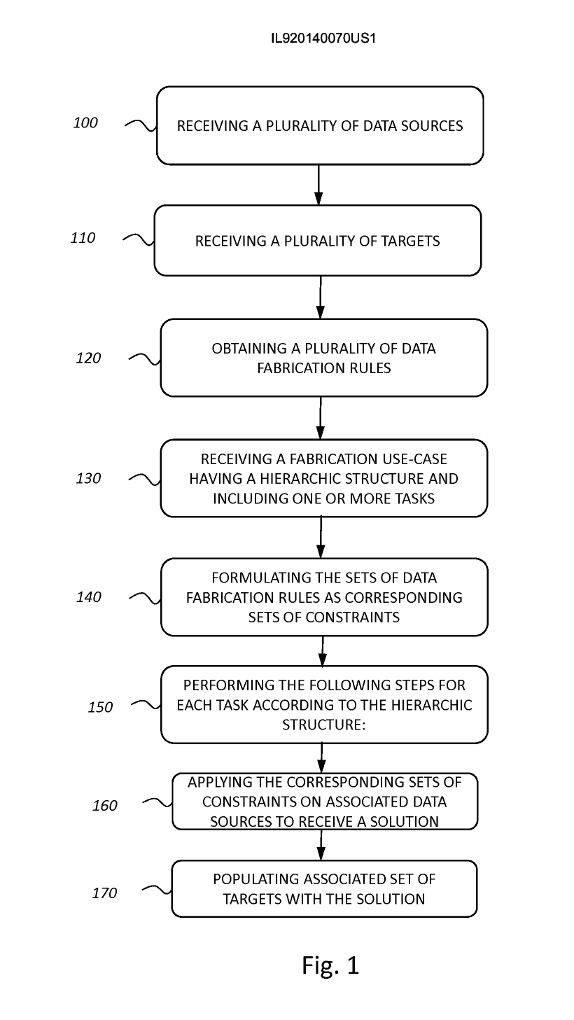

Reference is now made to FIG. 1, which shows a flowchart of a method, constructed and operative in accordance with an embodiment of the disclosed technique. In a step 100, a plurality of data sources may be received. The data sources may include various types of data, such as real world data, manually generated data, or the like. The data is assumed to have at least some relevance to data to be used by one or more applications, for example in order to test the applications. The data sources may include one or more knowledge-bases to be used with knowledge-base rules, as will be described below. A knowledge-base may include data to be used as test data for an application. Referring to the above mentioned example of testing a shop application, knowledge bases such as a knowledge base of US addresses (streets, cities, states, and zip codes), a knowledge base of last names, and a knowledge base of first names associated with gender may be used to fabricate client information.

The plurality of data sources may be defined by a user, e.g., a testing engineer. The method may be implemented as dedicated software. Such software may include a user interface, such as a Graphical User Interface (GUI), which may be used to receive information from a user. The user interface may thus allow a user to define such relevant data sources. Following that, a connection between the software and the plurality of data sources may be established.

In a step 110, a plurality of targets to be populated with the test data may be received. The targets may be, for example, tables of one or more databases, one or more attributes of such tables, one or more databases or any of a variety of formats, such as Extensible Markup Language (XML), Comma Separated Values (CSV) and Data Manipulation Language (DML) files. For convenience purposes only, and without exclusion of any other type of targets, the targets will be referred herein below as tables of a database. The plurality of targets may be defined by the user, e.g., via the user interface. A connection between the software and the plurality of targets may be then established.

In a step 120, a plurality of data fabrication rules (or simply “the rules”) may be obtained. The data fabrication rules may be defined to be applied on different entities in the targets and sources, such as one or more attributes of a table (i.e., a column of a table) or a table. The plurality of data fabrication rules may include data fabrication rules of one or more types, such as constraint rules, transformation rules, knowledge-base rules, programmatic rules, analytics rules and generic rules. In some embodiments the plurality of data fabrication rules may include data fabrication rules of two or more types.

Constraint rules may describe constraint properties relating to the targets characteristics, for example, to attributes of tables, which should be satisfied, such as a relation between two attributes or a domain of values for an attribute. For example, a constraint rule may define that the price of a product is between 10$ and 200$ (price>=10 and price<=200). It may also define a relation between multiple attributes, such as the total price of an order is the price of the product multiplied by the amount of products: (total=price*amount).

Transformation rules may describe a transformation that should be performed on one or more attributes of data from a data source including values to a target. Such rules may transform values from a source attribute into a target attribute of the same type, or of different types. For example, a transformation rule may define how to transform the data, such as moving a date attribute to one year ahead: (target.date=source.date+1 year).

Knowledge base rules may describe a resource of knowledge for one or more attributes. In such rules, the fabricated data may be selected from a set of possible values in the knowledge base. For example, a knowledge-base rule may define how to select values for certain attributes, such as first names and gender to be selected from a US repository (i.e., a knowledge-base): (first_name, gender)=chooseFrom(US.first_names_and_gender).

Programmatic rules may be embodied as pieces of code written in an operative language, such that when executed, result in a value for one or more attributes. Programmatic rules may receive inputs and produce outputs to be associated with attributes. In some embodiments, users may define programmatic rules to be used in the fabrication of data. For example, a programmatic rule may be a piece of code which may generate values according to some logic, such as a credit card info generator, which may produce random fake but valid credit card numbers and issuer names.

Analytics rules may provide some information concerning one or more attributes. According to some embodiments, analytics may be performed in a further step, as known in the art. Analytics may be performed with respect to data in order to extract a set of one or more properties which may characterize the data, such as distribution of one or more attributes, interdependency between attributes, or the like. At least some of the analytics rules may then be based on the analytics results. For example, an analytics rule may define how a set of attributes is distributed, such as the age and gender of clients: (target.age, target.gender)=distributedLike(source.age, source.gender).

According to some embodiments, analytics may be performed by external (third party) analytics tools and at least some of the analytics rules may be based on such analytics results. Such analytics tool may be any appropriate tool, such as IBM InfoSphere Discovery engine, provided by International Business Machines of Armonk, N.Y., United States.

A generic rule is a rule that may combine two or more types of rules. For example, a combination of a knowledge-base rule and a constraint rule may define how to fabricate a name which includes a family name and an initial (e.g., Salman T.) from a knowledge-base of family names and a knowledge-base of first names. The constraint rule portion may have the following pattern: target.name=source.last_name+‘ ’+substring (source.first_name, 0, 1), where last_name and first_name may be achieved by applying knowledge-base rules, e.g., as exemplified above. As another example, a combination of a programmatic rule and a constraint rule may define how to fabricate an invalid credit card number. A programmatic rule may be used to generate a valid credit card number and a constraint rule may be used to change the number to invalid one, such as: target.creditcard_number=CreditCardNumberRule.getValue( )+1, where the function CreditCardNumberRule represents the programmatic rule.

The data fabrication rules may be hierarchically structured. The rules may be organized and grouped in a hierarchical structure for ease of navigation and use. Rules defined in deeper levels of the hierarchy may be refinements to rules on higher levels.

In some embodiments, the obtaining of the data fabrication rules may include receiving at least a portion of the rules. For example, the rules (or a portion of them) may be defined by the user via the user interface. The user may further define a rule hierarchy. In some embodiments, the obtaining of the data fabrication rules may include automatically acquiring at least a portion of the plurality of rules from the involved environments, such as rules based on the referential integrity (primary or foreign keys) which constraint the possible values for the relevant attributes, or CHECK constraints (i.e., limiting the values in a target) defined in the Data Definition Language (DDL) of the target.

The data fabrication rules may be derived (i.e., automatically and/or manually) from sources such as the data (or database) logic, the application logic and the test logic. The data logic may, for example, may relate to the logic of the database to be populated and may include its referential integrity and CHECK constraints. The application logic may relate to the logic of the application for which test data is fabricated and may include, for example, relations between different attributes dictated by the application (e.g., the values of a social security number attribute are required to be valid social security numbers). The test logic may relate to the logic and purpose of the testing and may include, for example, rules dictated by the user to produce data that exercises specific test scenarios, including corner scenarios. For example, a rule may require that 90% of the orders processed have been cancelled within a week. The data logic, the application logic and the test logic may be extracted from the targets, the application and the test goals correspondingly by the user. Alternatively or additionally, the database logic may be extracted automatically according to the disclosed data fabrication techniques.

The data fabrication rules may be received, formed or clustered as sets of rules, e.g., according to their use and/or context. For example, rules which refer to the defining of client records may be clustered to a set of rules which may be classified as client creation rules. The clustering of the rules may allow an easier use, share and/or import/export of the rules.

In a step 130, a fabrication use-case having a hierarchic structure may be received. The fabrication use-case may include one or more tasks. Each task may be associated with a set of targets of the received targets and with one or more rules or sets of rules of the obtained rules. The fabrication use-case may include a set of use-cases. The set of use-cases may be hierarchically structured. Each use-case of the set of use-cases, which does not include a child use-case, may include at least one task of the one or more tasks (e.g., tables to be fabricated). Thus, each use-case in the bottom level of the hierarchic structure of the set of use-cases may include at least one task.

A parent use-case may include a set of child-use-cases. The one or more data fabrication rules or sets of data fabrication rules may be associated with each task in various hierarchic levels of the fabrication use-case, such as the fabrication use-case level, the use-cases level and the tasks level and according to the hierarchic structure of the rules. If rules are associated in the fabrication use-case level, then they are associated with and therefore may apply to all of the tasks of the fabrication use-case. If rules are associated in the use-cases level (i.e., associated with a specific use-case), then they are associated with and therefore may apply to the tasks of the specific use-case or of its child use-cases (if the specific use-case is a parent use-case). If rules are associated in the tasks level (i.e., associated with a specific task), then they are associated and therefore may apply to targets associated with the specific task. Thus, when referring to data fabrication rules associated with a task, such rules may include all of the data fabrication rules that may apply to the task regardless of the level of hierarchy in which they are defined, as described above.

Each task may be associated with at least one number of records of test data to be fabricated for each target associated with the task. Each such number of records may be associated in a hierarchic level of the fabrication use-case. A number of records to be fabricated may be associated in the fabrication use-case level, thus, applying to all of the targets associated with tasks of the fabrication use-case and thus associated with these tasks (i.e., indirectly). Alternatively or additionally, a number of records to be fabricated may be associated in the use-cases level, thus, applying to all the targets associated with tasks of the use-case or of its child use-cases (if the use-case is a parent use-case) and thus associated with these tasks (i.e., indirectly). Alternatively or additionally, a number of records to be fabricated for each target may be associated in the tasks level and/or in a target level (i.e., associated with a task and applying to a specific target). Thus, more than one number of records may be associated with a task (i.e., in different levels of the fabrication use-case). In such a case, the total number of records to be fabricated according to the task may equal the product of all such numbers.

The fabrication use-case may be defined by the user, e.g., via the user interface. The user may hierarchically define a set of use-cases. The user may then hierarchically define one or more tasks with respect to the set of use-cases and such that each use-case of the set of use-cases may include at least one task of the defined tasks. It should be noted with this respect that a task of a child use-case is considered as a task of the parent use-case as well. The user may then associate each task with one or more data fabrication rules or sets of data fabrication rules.

In a further optional step, suggestions may be automatically provided to the user for targets to be associated with a task. The suggestions may be according to the rules associated with the task (i.e., each rule may define its targets) and/or according to the known structural logic of the database, for example, by following referential integrity dependencies. Alternatively, the association of the targets may be performed automatically, as described above, e.g., by following referential integrity dependencies. In some embodiments, the user may associate each of at least a portion of the tasks with a targets of the plurality of targets. The user may further define the number of records of test data to be fabricated for each target associated with a task.

Once the child use-cases, their tasks, the targets and number of records to be fabricated are defined, the parent use-cases may be determined automatically in an optional step. These may be automatically computed since the targets associated, for example, with a parent use-case, are the union of the targets associated with its child use-cases and tasks.

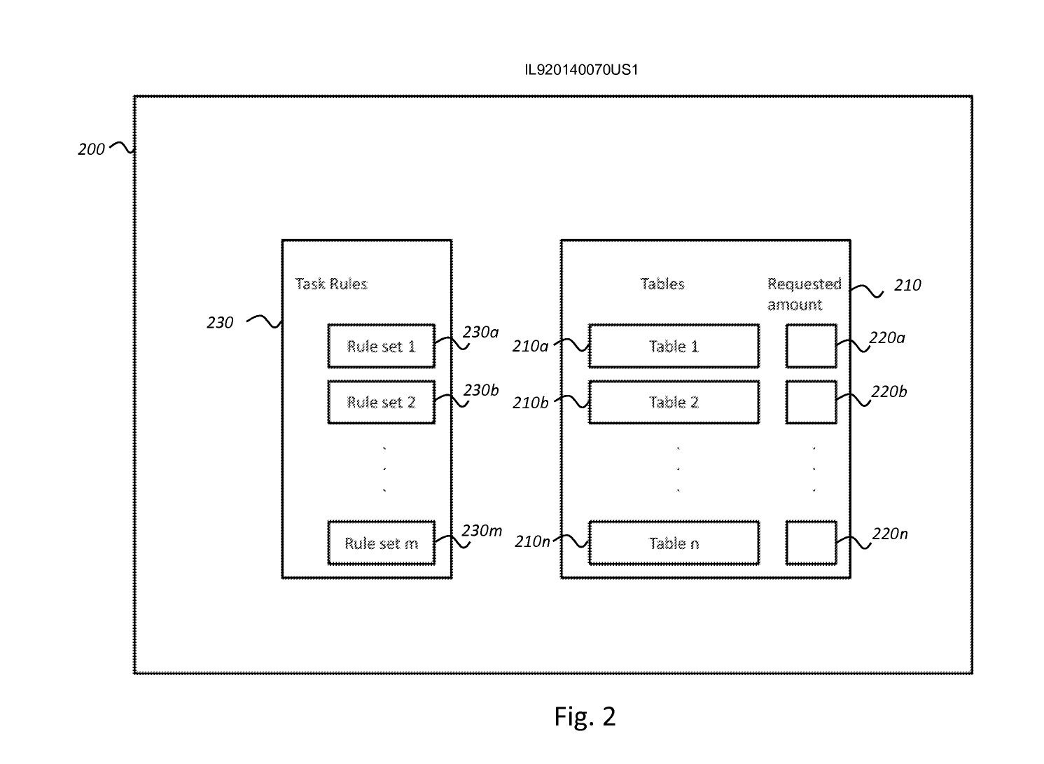

Reference is now made to FIG. 2, which shows an exemplary structure of a task 200 according to an embodiment. Task 200 may be associated with a set of tables 210 (i.e., targets). Tables set 210 may include n tables indicated 210a-210n accordingly. Task 200 may be further associated with a set of numbers of records 220a-220n corresponding to tables 210a-210n. For example, number 220a indicated the requested number of records for table 210a. Task 200 may be further associated with sets of rules 230. Sets of rules 230 may include m sets of rules to be applied in order to fabricate test data for the n tables. Each set of rules of the sets of rules 230 may apply to one or more attributes of one or more of tables 210a-210n.

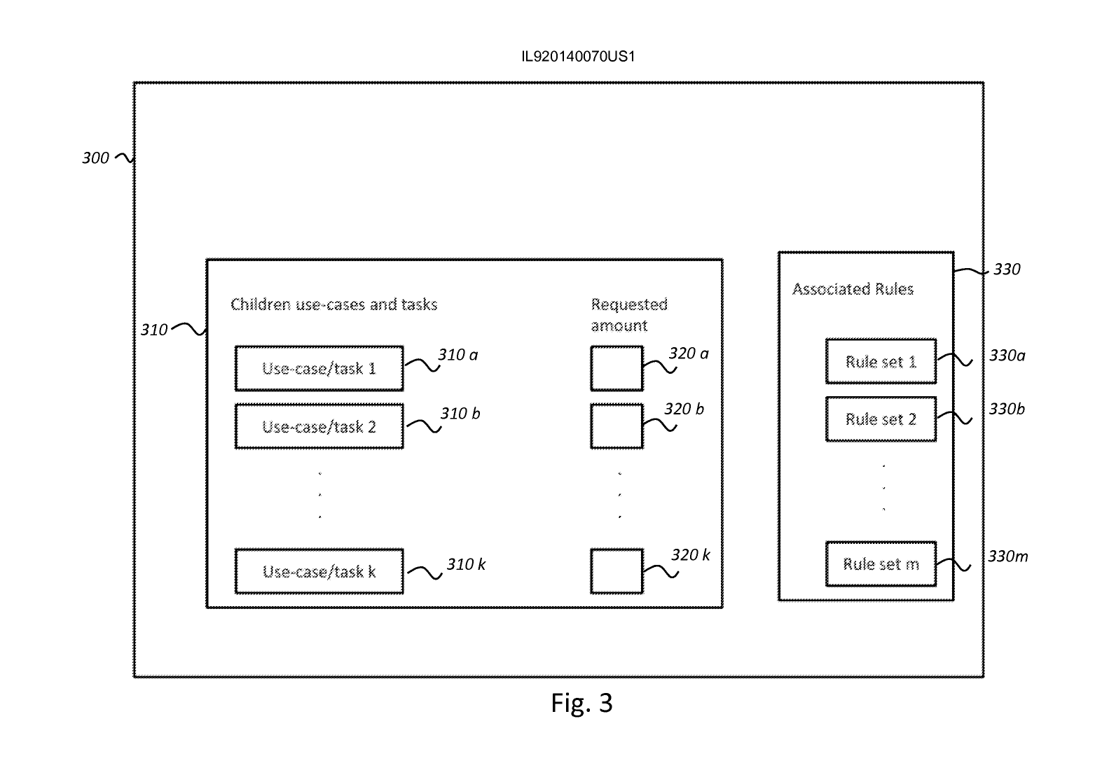

Reference is now made to FIG. 3, which shows an exemplary structure of a use-case 300 according to an embodiment. Use-case 300 is a parent use-case which includes a set of k children use-cases including tasks, while the set is indicated 310. In set 310, each use-case includes a task where the pairs of use-case-task are indicated 310a-310k accordingly. A number of records to be fabricated is associated with each use-case (i.e., associated in the use-cases hierarchic level). The numbers of records are indicated 320a-320k accordingly. M sets of rules 330, indicated 330a-330m accordingly, may be associated with use-cases-tasks set 310. Thus, each rule set of rules sets 330a-330m may associated with tasks of use-cases-tasks set 310.

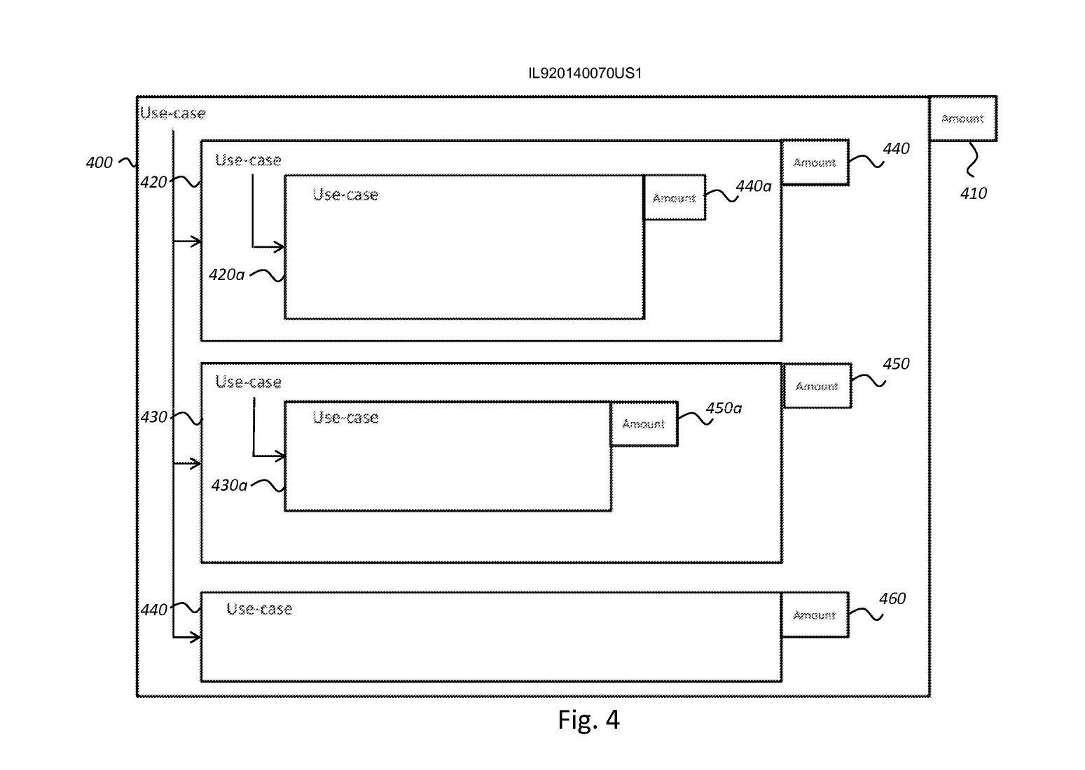

Reference is now made to FIG. 4, which shows an exemplary structure of a use-case 400 hierarchy according to an embodiment. Use-case 400 may be a parent use-case and may accordingly include child use-cases 420, 430 and 440. Child use-case 420 may be also a parent use-case and may include a child use-case 420a. Similarly, child use-case 430 may be also a parent use-case and may include a child use-case 430a. Use-case 400 may be associated with a number of records (or simply “amount”) 410. Amount 410 may determine the number of records fabricated for each task of use-case 400. Use-cases 420, 430 and 440 may be associated with amounts 440, 450 and 460, correspondingly. Amounts 440, 450 and 460 may determine the number of records to be fabricated for each task of use-cases 420, 430 and 440, correspondingly (e.g., amount 440 may determine the number of records to be fabricated for each task of use-case 420). Child use-cases 420a and 430a may be associated with amounts 440a and 450a, correspondingly. Amounts 440a and 450a determine the number of records to be fabricated for each use-case 420a and 430a, correspondingly. Thus, for each task of use-case 420a, the number of records to be fabricated equals: (amount 410)*(amount 440)*(amount 440a). For each task of use-case 430a, the number of records to be fabricated equals: (amount 410)*(amount 450)*(amount 450a). For each task of use-case 430a, the number of records to be fabricated equals: (amount 410)*(amount 460).

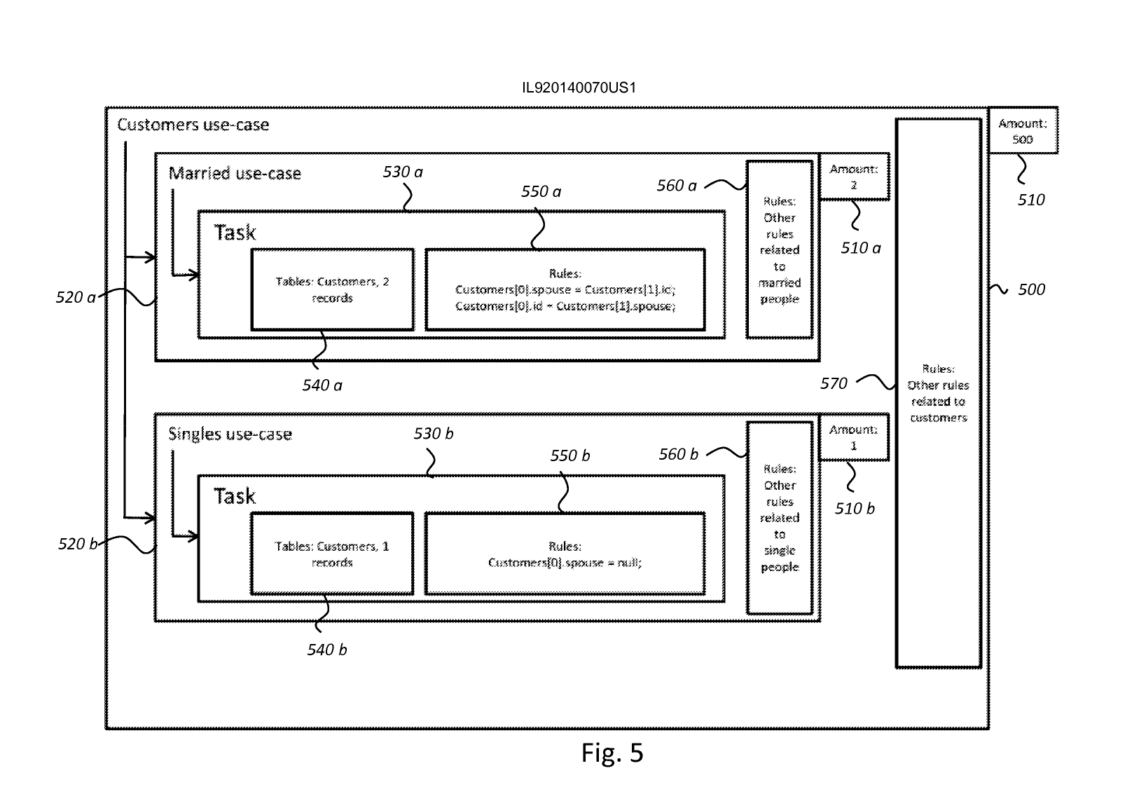

Reference is now made to FIG. 5, which shows an exemplary use-case 500 according to an embodiment. Customers use-case 500 may be a parent use-case which may include two child use-cases: a married use-case 520a and a single use-case 520b. Married use-case 520a may include a task 530a and single use-case 520b may include a task 530b. Customers use-case 500 may be associated with a number of records 510 which includes the amount: 500. Married use-case 520a may be associated with a number of records 510a which includes the amount: two. Singles use-case 520b may be associated with a number of records 510b which includes the amount: one. Task 530a may be associated with a customers table 540a which may include two records (i.e., according to the number of records associated with task 530a in the use-case level, i.e., number of records 510a). Task 530b may be associated with a customers table 540b which may include one record (i.e., according to the number of records associated with task 530b in the use-case level, i.e., number of records 510b). Customer tables 540a and 540b may be identical. Customer tables 540a and 540b may include two attributes: id (i.e., identity) and spouse. Task 530a may be further associated with rules 550a. According to rules 550a, the value of the id attribute for record [1] of the customers table is equal to the value of the spouse attribute of record [0] of the customers table and vice versa. Task 530b may be further associated with rules 550b. According to rules 550b, the value of the spouse attribute for record [0] of the customer table is null (i.e., invalid). Married use-case 520a may be associated with other rules 560a related to married people, which may apply to all of the tasks of married use-case 520a. Single use-case 520b may be associated with other rules 560b related to single people, which may apply to all of the tasks of single use-case 520b. Customers use-case 500 may be associated with other rules 570, which relate to customers in general (e.g., not discerning between married and single customers). Thus, rules 570, 560a, 560b, 550a and 550b form a hierarchic structure of rules. Married use-case 520a and single use-case 520b may be each fabricated 500 times according to number of records 510. Since married use-case 520a is further associated with number of records 510a, a total of 1,000 records may be fabricated for customers table 540a according to task 530a. Since single use-case 520b is further associated with number of records 510b, a total of 500 records may be fabricated according to task 530b. Overall a total number of 1,500 records may be fabricated for the tables associated with customers use-case 500.

In some embodiments, entities of the targets and of the sources may be tagged with stereotypes. A stereotype may be a textual tag. Entities of the targets and sources may be, for example, attributes of the targets or sources. In such embodiments the method may include further optional steps. In one optional step, one or more meta-rules defined to be enforced with respect to the entities tagged with the stereotypes may be received. Meta-rules may be rules that reference stereotypes. A meta-rule may address a combination of stereotypes and such entities.

In another optional step, the meta-rules may be instantiated to produce one or more data fabrication rules referring to the entities tagged with the stereotypes correspondingly. Each meta-rule may be instantiated to a collection of rules applied for each entity tagged with one or more stereotypes (i.e., an assembly of two or more stereotypes) referenced by the meta-rule. For example, certain attributes in the resources (i.e., sources and targets) may be tagged with stereotypes. These stereotypes may be used in meta-rules to define rules that may be enforced on all attributes belonging to the stereotypes. The entities may be tagged with stereotypes by the user, e.g., by a user interface. Default stereotypes may be automatically provided, for example, for each type of an attribute of a table.

For example, a stereotype <<PASTDATE>> may be created, and all date attributes that may represent dates in the past according to the application-logic, for example, may be associated with the stereotype. A meta-rule of a constraint type may then be defined and created specifying that all these dates are to be earlier than, for example, the first of January 2014: <<PASTDATE>> <Jan. 1, 2014. During the fabrication process of the test data (as detailed below), all meta-rules may be automatically instantiated to produce regular rules with attributes instead of stereotypes.

In some embodiments, entities such as target tables or attributes of such may be defined as one or more groups. Data fabrication rules and the stereotypes may be then defined with respect to the one or more groups. A group may be a logical collection of entities (such as attributes, tables, etc.) that may serve a given purpose. For example, a group that may serve employees may include a table of employee details, a table of salary, and the like. Rules and stereotypes may be applied to groups instead of the whole target. The user may also define such groups, e.g., by a user interface. For example, the user may define a stereotype for all date attributes in the employee group. Alternatively, the user may define a rule for a certain stereotype only in a group.

In a step 140, at least some data fabrication rules or sets of data fabrication rules may be formulated as corresponding one or more constraints or sets of constraints.

In an optional step, the generic rules may be parsed and divided into rule components.

In an optional step, for each analytics rule of the plurality of data fabrication rules, the following may be performed. The analytics defined in each analytics rule may be performed on at least one data source to receive one or more distributions. The received one or more distributions may be then formulated as one or more constraints. The distributions may be incorporated in a constraint satisfaction problem in further steps as detailed below, where choosing a value for a variable with distribution constraint is done according to the associated distribution.

When applying the analytics rule (e.g., by an analytics tool) on a data source, properties of data in the data source, such as data distribution, may be extracted. The extracted properties may be stored with the accordingly fabricated test data, or in a separate location which may be associated with the test data.

In an optional step, for each knowledge base rule, a knowledge base associated with each knowledge base rule may be read. A constraint may be formulated accordingly. The data sources may include such one or more knowledge bases.

In an optional step, each programmatic rule may be executed at least once for each associated target to receive at least one value for each associated target. If the programmatic rule is not constrained further (i.e., the target of the rule has no other constraints), then the programmatic rule may be applied and a value for the target may be received. If the programmatic rule is further constrained, then it may be executed many times to receive a large set of possible values. In such cases, the programmatic rule becomes similar to a knowledge-base rule. For example, a programmatic rule may generate credit card numbers. A further constraint rule may limit one or more of the digits of the desired credit card number. The programmatic rule may generate a credit card number at each execution. However, not all or even most of the generated numbers may not comply with the further constraint rule. Therefore, the programmatic rule may be executed many times in order to receive a collection of credit card numbers, to receive at least one such desired number (i.e., which complies with the further constraint).

In cases of huge knowledge bases, or distributions, approximations or chunking might be performed. For example a constraint according to a knowledge base rule, may be: first_name=chooseFrom(USA.first_names), where USA.first_names is a knowledge base. However, this knowledge base may include a set of millions of possible names. In such a case, a subset of these names may be selected, and the constraint may be: first_name=chooseFrom(subset).

In an optional step, the constraint rules may be formulated as constraints.

In a step 150, the following steps may be performed for each task of the fabrication use-case according to the hierarchic structure of the fabrication use-case. These steps may be performed in order to fabricate the test data according to the requirements and structure defined in the fabrication use-case. In some embodiments, the user may request the fabrication of data according to a fabrication use-case after he has defined the fabrication use-case. In some other embodiments, the fabrication process may initiate automatically after a fabrication use-case has been received. The fabrication process may be performed in a recursive manner and such that it traverses the hierarchy of the fabrication use-case top down, but performs the tasks in a bottom-up manner. When the fabrication process starts, connections may be made to all sources and targets.

In an optional step, each transformation rule associated with the task which is defined with respect to a data source, may be applied by applying the transformation defined by the transformation rule on the data source. This may be performed prior and/or after performing step 160 below.

In a step 160, the one or more constraints or sets of constraints may be applied on data sources of the plurality of data sources according to the hierarchic structure of the fabrication use-case to receive a solution (e.g., a set of values). The one or more constraints or sets of constraints may correspond to at least some data fabrication rules of the one or more data fabrication rules or sets of such rules, which are associated with the task, its use-case, parent use-case and fabrication use-case.

In an optional step, unrelated constraints may be identified. The unrelated constraints may be identified prior to the data fabrication process (i.e., prior to step 150). Some constraints may be unrelated to others, and thus may be solved immediately by choosing a value out of a defined solution domain or by substitution of values. The one or more constraints or sets of constraints may be then divided to unrelated constraints or sets of constraints accordingly for better scalability. The performing of the steps for each task according to step 150 and onward may be in a separate manner for each one of the unrelated constraints or sets of constraints and in parallel, thus allowing faster fabrication.

In some embodiments, the applying of the one or more constraints or sets of constraints on the data sources in order to receive the solution may include formulating and solving a Constraint Satisfaction Problem (CSP), as known in the art, according to the one or more constraints or sets of constraints.

In general, the test data may be generated using any known required method or solving tool, such as but not limited to a Constraint Satisfaction Problem (CSP) solver, a satisfiability (SAT) solver, a Satisfiability Modulo Theories (SMT) solver, or any other solvers.

In a step 170, the set of targets associated with the task may be populated with the solution to receive fabricated test data for the associated set of targets.

The applying of the one or more constraints or sets of constraints on data sources to receive the solution and the populating of the associated set of targets with the solution may be repeated for each task until the number of records associated with the task (i.e., including numbers of records associated with its use-case, parent use-cases and fabrication-use-case) is satisfied.

In some embodiment, if a number of records which may be fabricated for a target of a task does not comply with the number of records associated with the task, then approximating of values of records may be performed in order to receive the number of records associated with the task, and an appropriate message for the user may be issued.

In an optional step, the transformation defined by each transformation rule associated with the task which is defined with respect to a target may be applied on the target. This step may be performed after steps 150-170 are performed. In some embodiments, programmatic rules which require CSP solutions as inputs may be also applied after steps 150-170 are performed.

The data fabrication process may conclude once all requested amounts of records are fabricated.

The dedicated software may enable each user to share, import, or export his projects or parts of them with other users. By “project” it is meant a fabrication use-case and all of its associated resources (i.e., sources and targets). For example, the dedicated software may enable rule sharing and project sharing between different users. Thus, for example, users that define application-logic rules may share them between multiple projects while each project has its own testing-logic rules.

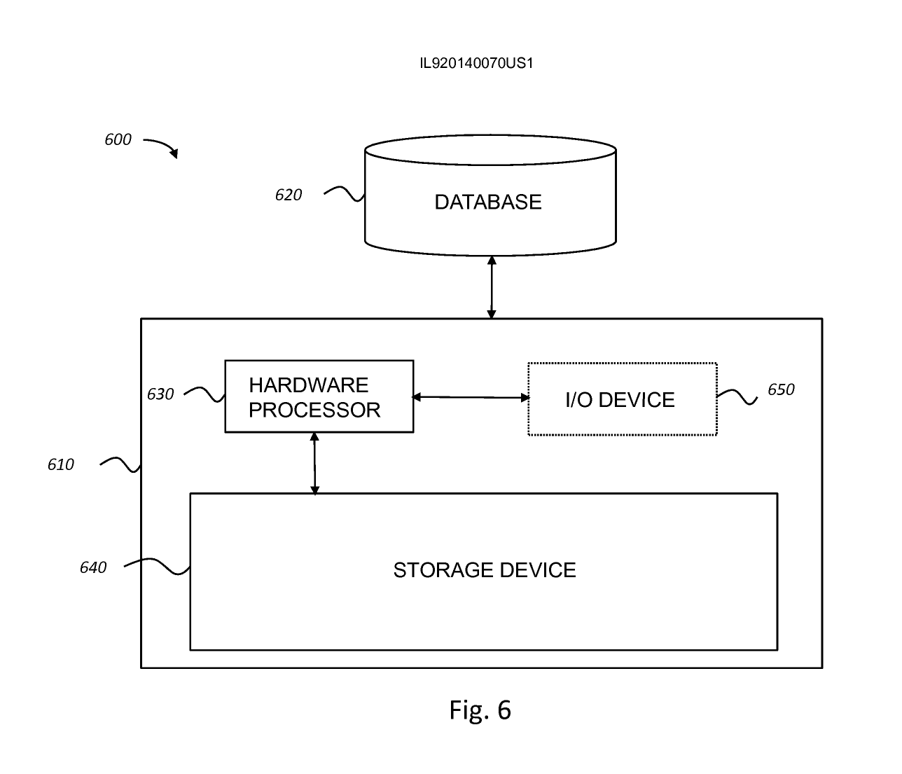

Reference is now made to FIG. 6, which shows an exemplary system 600 according to an embodiment. System 600 may include a computing device 610 and a database 620. Computing device 610 may include a hardware processor 630, a storage device 640 and an optional input/output (I/O) device 650. Database 620 may include one or more databases, hardware processor 630 may include one or more hardware processors and storage device 640 may include one or more storage devices. Database 620 may include the data sources and/or the targets or a portion of them. Alternatively or in addition, storage device 640 may include the data sources and/or targets or a portion of them. The fabricated test data may be stored in Database 620 and/or storage device 640. Hardware processor 630 may be configured to execute the method of FIG. 1 and, to this end, be in communication with database 620 and receive data therefrom. I/O device 650 may be configured to allow a user to interact with system 600. The dedicated software may be stored on storage device 640 and executed by hardware processor 630.

Database 620 may be stored on any one or more storage devices such as a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like. Database 620 may be a relational database, a hierarchical database, object-oriented database, document-oriented database, or any other database.

Hardware processor 630 may be a Central Processing Unit (CPU), a microprocessor, an electronic circuit, an Integrated Circuit (IC) or the like. Alternatively, computing device 610 may be implemented as firmware written for or ported to a specific processor such as digital signal processor (DSP) or microcontrollers, or can be implemented as hardware or configurable hardware such as field programmable gate array (FPGA) or application specific integrated circuit (ASIC). Hardware processors 630 may be utilized to perform computations required by computing device 610 or any of it subcomponents.

In some embodiments, computing device 610 may include an I/O device 650 such as a terminal, a display, a keyboard, a mouse, a touch screen, an input device or the like to interact with system 600, to invoke system 600 and to receive results. It will however be appreciated that system 600 can operate without human operation and without I/O device 650.

Computing device 610 may include one or more storage devices 640 for storing executable components, and which may also contain data during execution of one or more components. Storage device 640 may be persistent or volatile. For example, storage device 640 may be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like. In some exemplary embodiments, storage device 640 may retain program code operative to cause any of processors 630 to perform acts associated with any of the steps shown in FIG. 1 above, for example analyzing data for extracting rules, generating data in accordance with rules, or others.

In some exemplary embodiments of the disclosed subject matter, storage device 640 may include or be loaded with the user interface. The user interface may be utilized to receive input or provide output to and from system 600, for example receiving specific user commands or parameters related to system 600, providing output, or the like.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for fabricating test data, comprising using at least one hardware processor for:
receiving a plurality of data sources;
receiving a plurality of targets to be populated with the test data;
obtaining a plurality of data fabrication rules;
receiving a fabrication use-case having a hierarchic structure and comprising one or more tasks each associated with one or more data fabrication rules of the plurality of data fabrication rules and with a set of targets of the plurality of targets;
formulating at least some of the one or more data fabrication rules as corresponding one or more constraints; and
performing the following steps for each task of the one or more tasks of the fabrication use-case, according to the hierarchic structure of the fabrication use-case:
i) applying, to data sources of the plurality of data sources, the one or more constraints corresponding to at least some data fabrication rules of the one or more data fabrication rules associated with said each task, according to the hierarchic structure of the fabrication use-case, to receive a solution, and
ii) populating the associated set of targets with the solution, to receive fabricated test data for the associated set of targets.

2. The method of claim 1, wherein the fabrication use-case comprises a set of use-cases hierarchically structured, and wherein each use-case of said set of use-cases which is at the bottom level of the hierarchic structure of the set of use-cases comprises at least one task of said one or more tasks.

3. The method of claim 1, wherein:
each task of said one or more tasks is associated with at least one number of records of test data to be fabricated for each target of the set of targets associated with said each task,
each such at least one number of records is associated in a hierarchic level of the fabrication use-case selected from the group consisting of: a fabrication use-case level, use-cases level and tasks level, and
the applying of the one or more constraints on data sources to receive the solution and the populating of the associated set of targets with the solution are repeated for said each task until the total number of records associated with said each task is satisfied.

4. The method of claim 1, wherein the type of at least some of said plurality of data fabrication rules is selected from the group consisting of: constraint rules, transformation rules, knowledge-base rules, programmatic rules, analytics rules and generic rules.

5. The method of claim 4, further comprising using said at least one hardware processor for:
parsing and dividing generic rules of the plurality of data fabrication rules into rule components according to the types of the rule components;
for each analytics rule of the plurality of data fabrication rules:
i) performing the analytics defined in said each analytics rule on at least one data source of the plurality of data sources to receive one or more distributions, and
ii) formulating the received one or more distributions as one or more constraints;
for each knowledge-base rule of the plurality of data fabrication rules, reading a knowledge-base associated with said each knowledge-base rule and formulating a constraint accordingly, wherein said plurality of data sources comprises said knowledge-base;
for each programmatic rule of the plurality of data fabrication rules, executing said each programmatic rule at least once for each associated target to receive at least one value for said each associated target; and
formulating constraint rules of the plurality of data fabrication rules as constraints.

6. The method of claim 4, wherein the performing of the steps for each task of the one or more tasks further comprises performing the following steps:
i) for each transformation rule of the plurality of data fabrication rules which is defined with respect to a data source of the plurality of data sources, applying the transformation defined by said each transformation rule on the data source, and
ii) for each transformation rule of the plurality of data fabrication rules which is defined with respect to a target of the plurality of targets, applying the transformation defined by said each transformation rule on the target.

7. The method of claim 1, wherein the applying of the one or more constraints on the data sources comprises formulating and solving a Constraint Satisfaction Problem (CSP) according to the one or more constraints to receive the solution.

8. The method of claim 1 further comprising dividing the one or more constraints to unrelated constraints and performing the steps for each task in a separate manner for each one of the unrelated constraints.

9. The method of claim 1, wherein the data fabrication rules are hierarchically structured.

10. The method of claim 1, wherein the data fabrication rules are derived from sources selected from the group consisting of: data logic, application logic and test logic.

11. The method of claim 1, wherein entities of targets of the plurality of targets and of sources of the plurality of sources are tagged with stereotypes, and wherein the method further comprises using said at least one hardware processor for:
receiving one or more meta-rules defined to be enforced with respect to the entities tagged with the stereotypes; and
instantiating said one or more meta-rules to produce one or more data fabrication rules referring to the entities tagged with the stereotypes correspondingly.

12. The method of claim 11, wherein entities selected from the group consisting of: tables and attributes of tables are defined as one or more groups and wherein data fabrication rules of the plurality of data fabrication rules and the stereotypes may be defined with respect to the one or more groups.

13. The method of claim 1, wherein the one or more data fabrication rules are associated with said each task in a hierarchic level of the fabrication use-case selected from the group consisting of: a fabrication use-case level, use-cases level and tasks level.

14. A computer program product comprising a non-transitory computer-readable storage medium having program code embodied therewith, the program code executable by at least one hardware processor to:
receive a plurality of data sources;
receive a plurality of targets to be populated with the test data;
obtain a plurality of data fabrication rules;
receive a fabrication use-case having a hierarchic structure and comprising one or more tasks each associated with one or more data fabrication rules of the plurality of data fabrication rules and with a set of targets of the plurality of targets;
formulate at least some of the one or more data fabrication rules as corresponding one or more constraints; and
perform the following steps for each task of the one or more tasks of the fabrication use-case, according to the hierarchic structure of the fabrication use-case:
i) apply, to data sources of the plurality of data sources, the one or more constraints corresponding to at least some data fabrication rules of the one or more data fabrication rules associated with said each task and with each parent task of said each task, according to the hierarchic structure of the fabrication use-case, to receive a solution, and
ii) populate the associated set of targets with the solution, to receive fabricated test data for the associated set of targets.

15. The computer program product of claim 14, wherein the type of at least some of said plurality of data fabrication rules is selected from the group consisting of: constraint rules, transformation rules, knowledge-base rules, programmatic rules, analytics rules and generic rules.

16. The computer program product of claim 15, wherein the program code is further executable by said at least one hardware processor to:
parse and divide generic rules of the plurality of data fabrication rules into rule components according to the types of the rule components;
for each analytics rule of the plurality of data fabrication rules:
i) perform the analytics defined in said each analytics rule on at least one data source of the plurality of data sources to receive one or more distributions, and
ii) formulate the received one or more distributions as one or more constraints;
for each knowledge-base rule of the plurality of data fabrication rules, read a knowledge-base associated with said each knowledge-base rule and formulate a constraint accordingly, wherein said plurality of data sources comprises said knowledge-base;
for each programmatic rule of the plurality of data fabrication rules, execute said each programmatic rule at least once for each associated target to receive at least one value for said each associated target; and
formulate constraint rules of the plurality of data fabrication rules as constraints.

17. The computer program product of claim 14, wherein the applying of the one or more constraints on the data sources comprises formulating and solving a Constraint Satisfaction Problem (CSP) according to the one or more constraints to receive the solution.

18. A system comprising:
i) a storage device having stored thereon instructions for:
receiving a plurality of data sources,
receiving a plurality of targets to be populated with the test data,
obtaining a plurality of data fabrication rules,
receiving a fabrication use-case having a hierarchic structure and comprising one or more tasks each associated with a set of targets of the plurality of targets and with one or more data fabrication rules of the plurality of data fabrication rules,
formulating at least some of the one or more data fabrication rules as corresponding one or more constraints, and
performing the following steps for each task of the one or more tasks of the fabrication use-case, according to the hierarchic structure of the fabrication use-case:
(a) applying, to data sources of the plurality of data sources, the one or more constraints corresponding to at least some data fabrication rules of the one or more data fabrication rules associated with said each task and with each parent task of said each task, according to the hierarchic structure of the fabrication use-case, to receive a solution, and
(b) populating the associated set of targets with the solution, to receive fabricated test data for the associated set of targets; and
ii) at least one hardware processor configured to execute said instructions.

19. The system of claim 18, said storage device further having stored thereon instructions for:
parsing and dividing generic rules of the plurality of data fabrication rules into rule components according to the types of the rule components;
for each analytics rule of the plurality of data fabrication rules:
i) performing the analytics defined in said each analytics rule on at least one data source of the plurality of data sources to receive one or more distributions, and
ii) formulating the received one or more distributions as one or more constraints;
for each knowledge-base rule of the plurality of data fabrication rules, reading a knowledge-base associated with said each knowledge-base rule and formulating a constraint accordingly, wherein said plurality of data sources comprises said knowledge-base;
for each programmatic rule of the plurality of data fabrication rules, executing said each programmatic rule at least once for each associated target to receive at least one value for said each associated target; and
formulating constraint rules of the plurality of data fabrication rules as constraints.

20. The system of claim 18, wherein the applying of the one or more constraints on the data sources comprises formulating and solving a Constraint Satisfaction Problem (CSP) according to the one or more constraints to receive the solution.
